(19) United States
(12) Patent Application Publication
(10) Pub. No.: US 2001/0037691 A1
(43) Pub. Date: Nov. 8, 2001

(54) Method for evaluating mechanical driving characteristics of driving unit of storage medium disk and apparatus therefor

(76) Inventor: Tetsuji Higashijima, Kawaski-shi (JP)

Correspondence Address: Gerald Levy, Pitney, Hardin, Kipp & Szuch LLP, 711 Third Avenue, New York, NY, 10017, US

(21) Appl. No.: 09/770,803

(22) Filed: Jan. 26, 2001

(30) Foreign Application Priority Data
Jan. 28, 2000 (JP) 2000-20020
Apr. 11, 2000 (JP) 2000-109227

(51) Int. Cl. G01L 3/00

(52) U.S. Cl. 73/862.08

(57) ABSTRACT

A method comprising the steps of: measuring torque of a whole of a driving unit over a predetermined period; and determining mechanical driving characteristics of the driving unit from the time variation of the measured torque value. An apparatus adapted for the method, comprising: a torque sensor 12 removably mounted to a driving unit 10 having a disk rotating mechanism including a storage medium disk 1, and a storage information track tracking mechanism including a read head 2 provided for reading storage information from the storage medium disk 1; and an evaluation processing unit (ES) having a ROM for storing an operation program to process a torque detection signal, a RAM for temporarily storing data of the torque detection signal and processing signals, a processing portion, a display/recording unit, and a switching unit for sending a measurement start/stop instruction signal to an electronic control unit (DT) for supplying a driving current to a motor 6 of the disk rotating mechanism.

### BACKGROUND OF THE INVENTION

1. Field of the Invention

The present invention relates to a method for evaluating mechanical driving characteristics of a driving unit of a storage medium disk, said driving unit having a storage medium disk rotating mechanism containing an electric motor, and a storage information track tracking mechanism containing a read head provided for reading storage information written in a storage medium disk; and relates to an apparatus for carrying out the method.

2. Description of the Related Art

The storage capacity and seek speed of an information storage device such as a floppy disk storage device, an optical disk (MO, DVD, etc.) storage device or ahard disk storage device mounted in a computer have increased rapidly with the remarkable advance of a computer in recent years. For improvement in such performance, it is essential to improve performance and reliability of main constituent parts such as a recording/reproducing head, an information storage disk, a driving unit (spindle motor), etc. Further, it is also an important issue to improve evaluating/inspecting techniques in a site of development/production of the constituent parts.

For example, in the case of a hard disk device, if the disk rotating at a high speed comes into contact with the head, the head or the disk is damaged by the shock of the contact so that the head or the disk cannot endure use unfavorably. To prevent this, in an ordinary disk driver, a method is employed in which, during the stoppage of the disk, the head is positioned to come into contact with the disk or retreated to a predetermined position, and the head is floated up above the disk by air force generated by the disk contacting with air when the disk rotates at a high speed. In this case, the gap between the head and the disk may be not larger than several tens of nanometers. Hence, there are a lot of problems concerning management of quality such as a condition of pressing of the head onto the disk at a stationary state, the surface roughness, the lubricating state and the waviness of the head/disk at the rotating-state, etc.

For example, there is a limitation in an electric power supplied to a rotating motor of a driving unit used in a notebook type personal computer. Hence, in the worst case, the head is adhered to the disk thereby making the disk not rotatable. In the case of the hard disk, when the head moves at a high speed with a very small air gap above a surface of a storage medium (such as a disk), and the air gap changes to cause the disk to come into contact with the head, the disk and the head may be damaged. In the worst case, there is a risk that a serious trouble bringing about destruction may occur. To prevent this trouble, it is necessary to confirm whether the head runs in an ideal motion in accordance with a designed value or not.

The driving unit is installed in a relatively small and flat casing which is made extremely small in height from the requirement that space occupied by the apparatus such as a personal computer in which the driving unit is received therein needs to be made as small as possible. Therefore, a unique idea is applied to a magnetic track tracking mechanism of the head and a rotating mechanism of the disk. In the development of the driving unit or for inspection of characteristics in the actual production line of the driving units, it is practically useful to exactly understand the dynamic mechanical characteristics of the actual driving unit, such as starting operation, stopping operation, friction state between the disk and the head, the operating state of the head, or the like.

Heretofore, in order to evaluate driving characteristics of the driving unit (spindle motor) for rotating the disk in a hard disk device, an optical disk device (such as CD, DVD, MOD, etc.), a floppy disk device, or the like, and friction/contact characteristics between the head and the disk, it was necessary to open a cover of a device housing and to mount an optical encoder onto a driving portion of the disk device for measuring the rotational speed or to mount a sensor such as a strain gauge onto a driving portion of the disk device for measuring friction. In the method of this type, there was a problem that much labor was required for opening the cover of the device housing and mounting the sensor to the disk device and working efficiency was worse. Furthermore, there was a risk that parts of the disk might be damaged. It was impossible to make such an inspection on the finished products which were ready for shipping.

### SUMMARY OF THE INVENTION

An object of the present invention is to provide a method in which the mechanical driving characteristics of a storage medium driving unit can be evaluated in an actual mounting state without dismantling the finished driving unit and without modifying the driving unit, and to provide an apparatus suitable for the method.

According to the present invention, the foregoing object is achieved by a method of such a type as described in the introduction of this specification, the method comprising the steps of: measuring the torque of a whole of the driving unit over a predetermined period of rotation; and determining mechanical driving characteristics of the driving unit from the time variation of the measured torque value.

Further, the foregoing object is achieved by an apparatus suitable for the above method according to the present invention, comprising:

a torque sensor 12 removably mounted to a driving unit 10 having a disk rotating mechanism including a storage medium disk 1, and a storage information track tracking mechanism including a read head 2 provided for reading storage information from the storage medium disk 1; and an evaluation processing unit (ES) having a ROM for storing an operation program to process a torque detection signal, a RAM for temporarily storing data of the torque detection signal and processing signals, a processing portion, a display/recording unit, and a switching unit for sending a measurement start/stop instruction signal to an electronic control unit (DT) for supplying a driving current to a motor 6 of the disk rotating mechanism.

Other advantageous features of the present invention will be stated in depending claims of this application.

### BRIEF DESCRIPTION OF THE DRAWINGS

FIG. 1 is a schematic diagram showing the time dependence of disk rotational speed (C₁) and friction coefficient (C₂) between a disk and a read head, characterizing disk driving characteristics at the start/stop state of a motor;

FIGS. 2(a) and 2(b) schematically show the elements inside a driving unit,

FIG. 2(a) being a plan view of the casing where an upper portion thereof being removed,

FIG. 2(b) being a side view of the casing where a side portion thereof being removed;

FIG. 3 is a schematic diagram showing the arrangement of a measuring system and the configuration of circuits attached thereto;

FIG. 4 is a diagram schematically showing a geometrical relationship between the read head and the torque sensor;

FIG. 5 is a diagram showing the time variation of a measured torque value in a period from the start of rotation of the disk to the shifting of the rotation to a steady state;

FIG. 6 is a diagram showing the time variation of a time-integrated value of the measured torque value in FIG. 5;

FIG. 7 is enlarged diagrams of FIG. 6 in a vicinity of a start point of rotation (α) and in a vicinity of an arriving point of a steady rotation state (β);

FIG. 8 is a diagram showing the time variation of a motor driving current under a condition corresponding to those in FIG. 5;

FIG. 9 is a diagram showing the time variation of a time-integrated value of the driving current in FIG. 8;

FIG. 10 is a diagram showing the time variation of the difference between the time-integrated torque value in FIG. 6 and the time-integrated motor driving current value in FIG. 9;

FIG. 11 is a diagram showing the time variation of a time-integrated value of the measured value of torque characteristic at the start of rotation in the case where the read head is mounted/dismantled;

FIG. 12 is a diagram showing the time variation of a time-integrated value of the measured value of torque characteristic at the stop of rotation in the case where the read head is mounted/dismantled; and

FIGS. 13(a) to 13(c) are enlarged diagrams showing the time variation of a torque value of a fluctuating portion Γ₂ in FIG. 5 and once and twice time-integrated values of the torque value respectively.

### DETAILED DESCRIPTION OF THE INVENTION

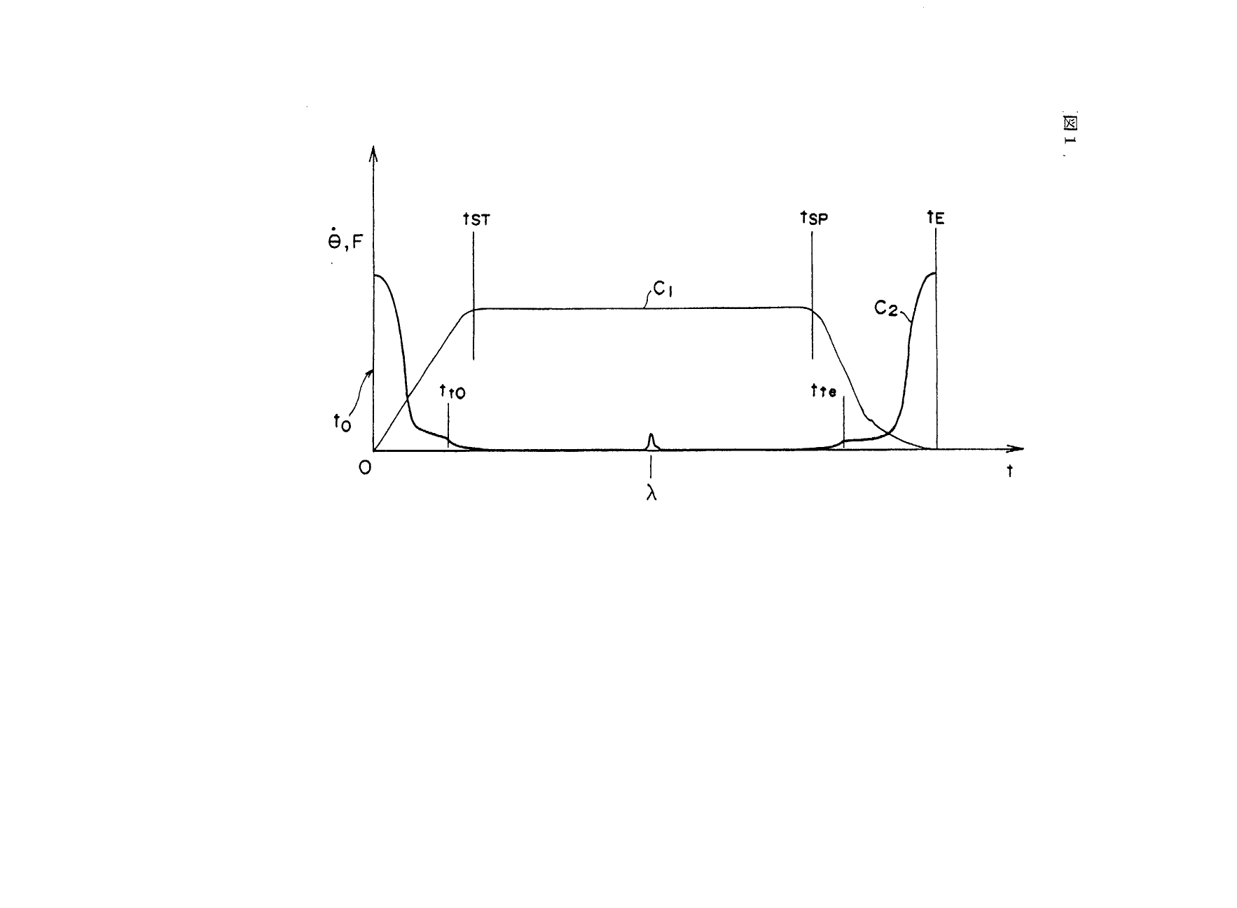

The mechanical driving characteristics concerning the rotation of a disk are determined from the friction force F between a disk surface and a read head as well as the structure of a rotation driving portion itself, that is, a motor, a bearing, a disk, or the like. FIG. 1 schematically shows the relation between the rotational speed dθ/dt of the disk (curve C₁) and the friction force F with respect to time t (curve C₂). As the motor starts to rotate at time t₀(=0), the rotational speed increases with time t. After a predetermined time (t_{ST}), the rotation of the disk reaches a steady state of rotation (constant-speed rotation). To stop the disk, an electric source of the motor is turned off. When the electric source of the motor is turned off at a specific point of time (t_{SP}) at which the disk is in the steady state of rotation, the rotational speed gradually decreases and finally reaches zero at time t_{E}. As well known, when the motor starts to rotate, the largest static friction initially acts between the disk surface and the read head. As the rotational speed increases, the static friction decreases so that the state of friction becomes sliding or dynamic friction. Then, the head is departed from the disk surface at a certain point of time (tₜ₀), so that the head gets a so-called floating state so as to be free from the influence of friction.

In order to stop the rotation, the motor is turned off at a point of time (tₛₚ). After then, the rotational speed of disk decreases and the head which is in the floating state descends onto the disk surface at a certain point of time (tₜₑ) Thus, the head comes into contact with the disk surface, so that friction force is generated again between the disk surface and the head. In this manner, braking force is generated. Even in the case where the read head is in such a floating state, the disk surface and the read head may substantially come into contact with each other because of foreign matter, mechanical damage, roughness, or the like, on the disk surface, for example, as shown in the point (t=λ) in FIG. 1 (instantaneous solid contact). Incidentally, in the graph of dθ/dt in FIG. 1, fluctuation at the point of time t=λ is not shown in order to avoid confusion.

By measuring such driving torque characteristic and/or motor energizing current characteristic at the start of rotation, at the stop of rotation and at the unexpected solid contact, the quality of relevant parts such as a motor, a bearing, etc., the quality of an electrical control system, and so on can be evaluated and estimated. On the basis of the evaluation, variations in quality of respective driving portions and the changes of the driving portions from their initial characteristics after being used for a long term can be estimated. Hence, the evaluation can also be used in an endurance test.

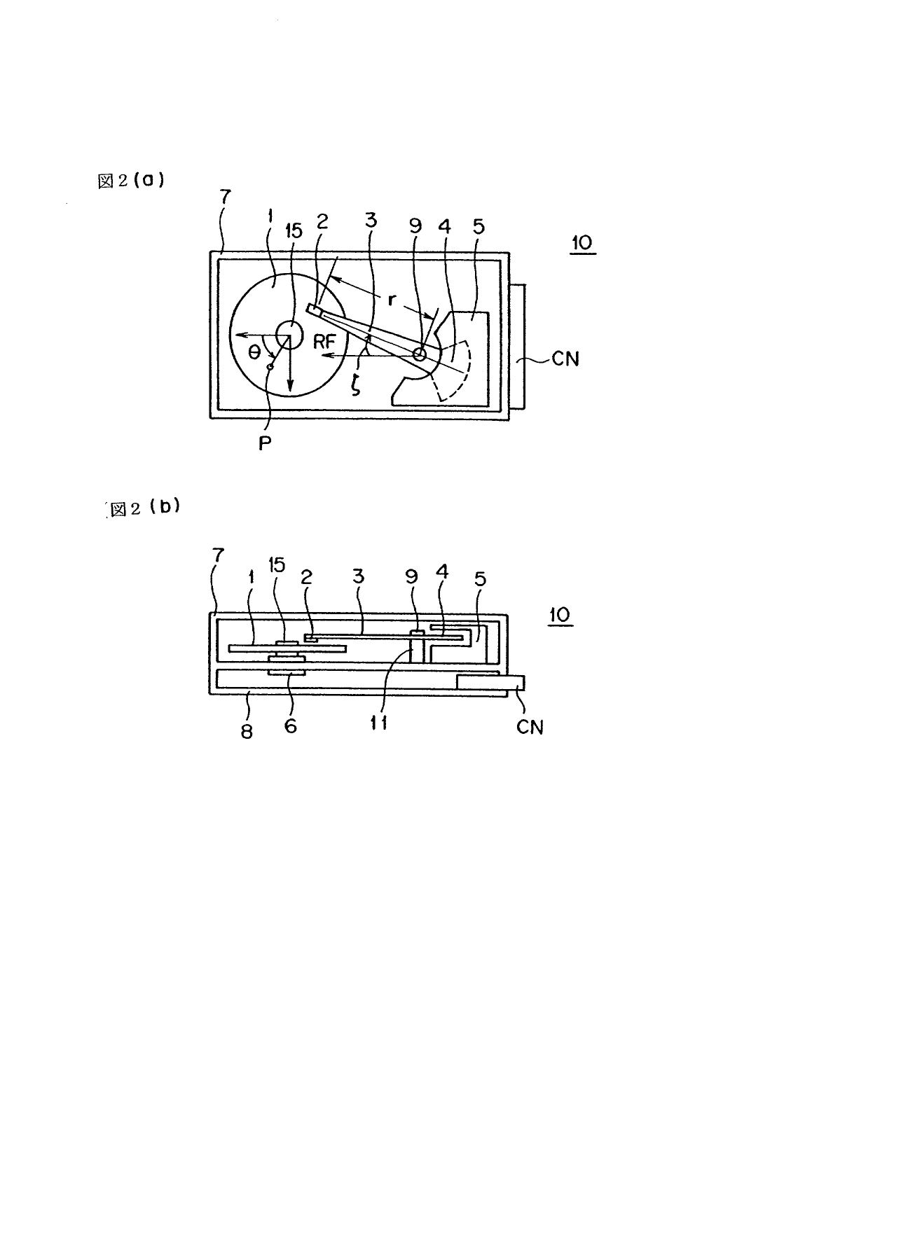

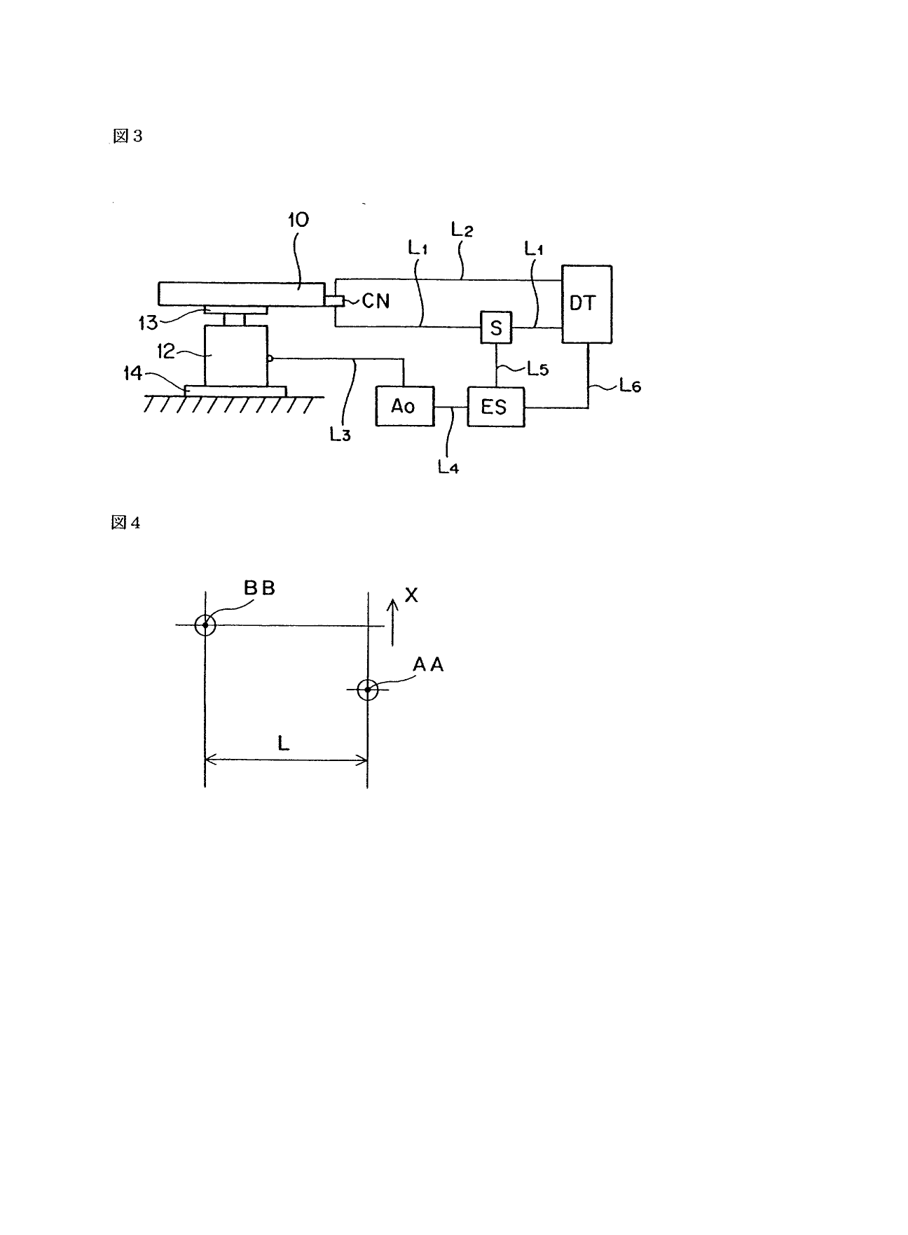

FIGS. 2(a) and 2(b) show the schematic structure of a driving unit 10 in the case of a hard disk. The driving unit 10 is constituted by a casing 7 shaped like a flat rectangle, and a driving mechanism incorporated in the casing 7. The hard disk 1 is fixed to a shaft 15 of a disk-rotating motor 6 fixed to a bottom portion of the casing 7. The head 2 is provided for reading information from a magnetic recording track on a surface of the hard disk 1 and is fixed to an end portion of an arm 3. The arm 3 is connected to a bearing 9 of a support 11 fixed to the casing 7 so that the arm 3 can turn. An armature 4 is provided in the other end portion of the arm 3 so that the head 2 is moved in a direction of the radius of the disk 1 so as to follow the recording information track. A head-driving stator 5 corresponding to the armature 4 is disposed so as to face the armature 4.

Further, a printed circuit board 8 having electronic parts (not shown) mounted thereon to control the electrical driving portion is disposed in the bottom portion of the driving unit 10. A connector CN for supplying disk-driving electric power and control signals from the outside is mounted to an end of the printed circuit board 8.

To evaluate the dynamic mechanical characteristics of the disk and the read head at the time of the rotation of the disk, a torque sensor 12 is fixed to the driving unit 10 as shown in FIG. 3. On this occasion, a mount jig 13 is removably mounted to the outside of the bottom portion of the driving unit 10 which is to be inspected, and the torque sensor 12 is fixed to the mount jig 13, the toque sensor 12 being grounded through a base plate 14 which is mounted on the ground. The torque sensor 12 used herein is of a non-rotation type.

Further, as shown in FIG. 3, the energizing current for the rotation-driving motor in the driving unit 10 is supplied from an electronic control portion DT through a lead wire L1 to the connector CN of the printed circuit board 8. On this occasion, a current sensor S is provided in the lead wire L1 in order to measure the energizing current intensity of the motor. Further, other control signals such as a mode-change control signal, a start/stop control signal are led into the connector CN directly from the electronic control unit DT through a lead wire L2 thereby enabling the disk to be rotated to read information stored in the disk. The driving unit 10 and the electronic control unit DT form a magnetic recording apparatus.

On the other hand, a signal detected by the torque sensor 12 is supplied to a preamplifier A0 through a lead wire L3. In the preamplifier A0, the signal is filtered and amplified. Then, the electric detection signal thus filtered and amplified is supplied through a lead wire L4 to an evaluation processing unit ES which evaluates disk-driving characteristic. From the evaluation processing unit ES, an electric driving signal corresponding to the energizing current of the disk-driving motor is further supplied to the current sensor S through a lead wire L5. A start control signal for the start of measurement and a stop control signal for the stop of measurement are sent from the evaluation processing unit ES to the electronic control unit DT through a lead wire L6 for the report and instructions. In the evaluation processing unit ES, dynamic driving characteristics of the driving unit are analyzed on the basis of both of the electric detection signal corresponding to the applied torque and the electric driving signal corresponding to the energizing current.

The content of analysis carried out in the evaluation processing unit ES will be described below in detail. When the read head is not controlled, the equation of motion of the whole system of movable members containing the read head and the disk is given as the expression (1):

$$I \frac{{ⅆ}^{2} θ ( t )}{ⅆ {t}^{2}} + F ( t ) = Ki ( t ) \qquad ( 1 )$$

in which I is the secondary moment of inertia of the rotation-driving system containing the disk and a rotor of the motor, K is a conversion coefficient for converting the motor-driving current into torque, θ(t) is the rotation angle of the disk at a point of time t, F(t) is friction torque at the point of time t, and i(t) is a current supplied to the motor at the point of time t. Incidentally, the rotation angle θ of the disk 1 in FIG. 2(a) with respect to the reference coordinates is to be referred to.

Further, the quantity of the first term in the left side of the expression (1) is expressed as inertial torque DΘ(t) That is,

$$D Θ ( t ) ≡ I \frac{{ⅆ}^{2} θ ( t )}{ⅆ {t}^{2}} = I \ddot{θ} ( t ) \qquad ( 2 )$$

If the torque sensor is disposed between the disk and the motor for measuring torque, a quantity corresponding to all the terms in the left side of the expression (1) is measured so that the first and second terms cannot be detected separately. To measure inertial torque DΘ(t) directly, the rotation acceleration of the rotation shaft of the motor must be measured directly under the condition that the casing of the driving unit is opened. In this case, measurement is made under the condition different from that of the finished product itself because the torque sensor and the acceleration sensor are mounted to the rotation shaft. However, if the following method is used, inertial torque DΘ(t) can be measured accurately even though the method is not direct but indirect.

When the disk is rotated by the motor, moment reverse to inertial torque of the rotor occurs in the stator of the motor. The reverse moment is transmitted to the casing of the driving unit. If the casing 7 of the driving unit 10 is fixed to the ground, the reverse moment is transmitted to the ground. Hence, as shown in FIG. 3, when the torque sensor 12 is disposed between the ground and the casing 7, inertial torque DΘ(t) can be measured as the reverse moment by the torque sensor 12. Hence, in the method according to the present invention, friction torque in the second term in the left side of the expression (1) is not mixed with the value measured by the torque sensor.

Next, the rotational speed at the point of time t, that is, the rotational number, is expressed as Δθ(t). That is,

$$Δ θ ( t ) ≡ \frac{ⅆ θ ( t )}{ⅆ t} = \dot{θ} ( t ) \qquad ( 3 )$$

The torque q(t) detected by the torque sensor is time-integrated from a point of time t₁ to a point of time t₂ and the thus obtained integral value is expressed as Q (t₂, t₁) That is,

$$Q ( {t}_{2} , {t}_{1} ) ≡ {\int }_{{t}_{1}}^{{t}_{2}} q ( t ) ⅆ t \qquad ( 4 )$$

Assuming now that the disk starts to rotate at a point of time t₀ and that the rotation reaches a steady state at a point of time tᵤ, the inertial torque DΘ(t) is time-integrated up to the point of time tᵤ as follows.

IΔθ(tᵤ)=−Q(tᵤ,tₒ) (5)

Hence, the inertial moment I is obtained by the expression (6).

I=−Q(tᵤ,tₒ)/Δθ(tᵤ) (6)

The angular speed Δθ(t₁) at the point of time t₁, (t₁<tᵤ) in the rotation acceleration period is given by the following expression (7) using the inertial moment I.

Δθ(t₁)=Q(t₁,tₒ)/I (7)

Practically, if torque is measured from the point of time at which the disk starts to rotate to the point of time at which the rotation is stabilized and Δθ(tᵤ) is calculated after storage of the data, the angular speed Δθ(t₁) at an optional point of time in the duration where the rotational speed of the disk is accelerated can be obtained on the basis of the expression (7). The same rule can also be applied to the case where the disk is to be stopped. If the same rule is used with respect to each of individual disks and without giving any special change to the driving unit, the change of rotation at any optional point of time in the period from the point of time at which the disk starts to rotate to the point of time at which the rotation is stabilized can be measured. Hence, the inspection of variation in quality and a benchmark test concerning change in use for a long term can be made.

With respect to the rotation stop operation, if the point of time at which the stop operation starts is represented by t₃, the angular speed Δθ(t₄) at a point of time t₄ in the stop period can be obtained by the following expression (8).

Δθ(t₄)=Δθ(tᵤ)+I·Q(t₄,t₃) (8)

If the motor in the stop operation does not perform any control operation and if the air frictional resistance of the disk and the sliding resistance of the bearing are ignored, the frictional torque F of the head is given by the expression (9):

F(t₄₎₌₋q(t₄) (9)

in which q(t₄) is the output of the torque sensor at the point of time t₄. Even in the case where the motor is performing a control operation, the frictional torque F is given by the following expression (9′) if torque due to the control operation is known as q_{c′}(t₄).

F(t₄)=−q(t₄)−q_{c′}(t₄) (9′)

Because the angular speed θ(t₄) is a function of t₄, the frictional force F(t₄) can be obtained as a function of the angular speed of the disk rotation.

When there is a difference in the friction between at the start of rotation and at the stop of rotation, it is necessary to obtain the friction at the start of rotation. The expression (1) can be rewritten as follows.

F(t)=i(t)K−DΘ(t) (1′)

Because DΘ(t) in the expression (1′) can be determined from the output of the torque sensor as described above, the expression (1′) can be further rewritten as follows.

F(t₁)=i(t₁)K+q(t₁) (1″)

If the current/torque conversion coefficient of the motor is known, the frictional force F at an optional point of time can be obtained on the basis of the expression (1″) and the measured value of the current.

When the head collides with the disk and the collision causes damage on the disk, frictional force changes dramatically before and after the damage. On this occasion, braking force acts on the disk, so that inertial torque DΘ(t) is generated and the angular speed changes. The current increases to eliminate the change of the angular speed. Accordingly, the state of damage can be observed by the expression (1′) on the basis of the torque signal and the current signal.

Next, the operation of the read head 2 will be described. After the rotation of the disk 1 reaches a steady state, the head 2 rotates around the rotation shaft of the bearing 9 to seek a necessary storage position on the disk. In this case, assume that I_{H} is the total inertial moment of all the rotating portions (also referred to as an actuator) containing the head 2, the arm 3, the armature 4, etc., ζ is the angular position of the head 2 with respect to a reference position RF, and r is the distance between a main contact portion of the head 2 and the center of rotation of the same head 2. On this occasion, if the actuator is out of dynamic balance, the head 2 may move in the direction other than the in-plane direction shown in FIG. 2(a). Assume now that the influence of such actuator imbalance can be ignored because the imbalance is generally eliminated sufficiently. That is, assume that it is sufficient if only the in-plane rotation of the head 2 is considered.

Under the condition that no torque but motion of the read head 2 is generated in the driving unit 10, moment expressed as the following expression (10) acts on the torque sensor 12.

$${M}_{H} ( t ) = {I}_{H} \frac{{ⅆ}^{2} ζ ( t )}{ⅆ {t}^{2}} = {I}_{H} \ddot{ζ} ( t ) \qquad ( 10 )$$

Assume now that the initial conditions for starting the rotation of the head 2 are as follows.

Initial point of time: t₀

Initial angular position: ζ_{Ho} (11)

Initial angular speed: ω_{HO}

The rotational speed of the head 2 and the angular position of the head 2 at a point of time t are obtained as the following expressions, from the expression (10).

$$\begin{matrix}\dot{ζ} ( t ) = {\int }_{{t}_{0}}^{t} {M}_{H} ( t ) / {I}_{H} ⅆ t + {ω}_{HO} & ( 12 ) \\ ζ ( t ) = {\int }_{{t}_{0}}^{t} ⅆ {t}_{1} {\int }_{{t}_{0}}^{{t}_{1}} ⅆ {t}^{′} {M}_{H} ( {t}^{′} ) / {I}_{H} + {ω}_{HO} ( t - {t}_{0} ) + {ζ}_{HO} & ( 13 )\end{matrix}$$

Hence, the rotational acceleration HA, rotational speed HV and rotational angular position HP of the read head 2 can be obtained from the expressions (10), (12) and (13) respectively.

$$\begin{matrix}HA = {rM}_{H} ( t ) / {I}_{H} \\ HV = r \frac{ⅆ ζ ( t )}{ⅆ t} = r \dot{ ζ} ( t ) \\ HP = r ζ ( t )\end{matrix} \} \qquad ( {13}^{′} )$$

As is obvious from the expression (10), in the case where the actuator is in dynamic balance, the inertial force in rotation of the actuator is pure moment. The output of the torque sensor 12 is also moment. Hence, the torque sensor 12 can measure torque generated from the actuator on the basis of the expression (10) regardless of the mount position of the torque sensor 12 as far as the torque generated in the driving unit 10 does not generate from the unit other than the actuator.

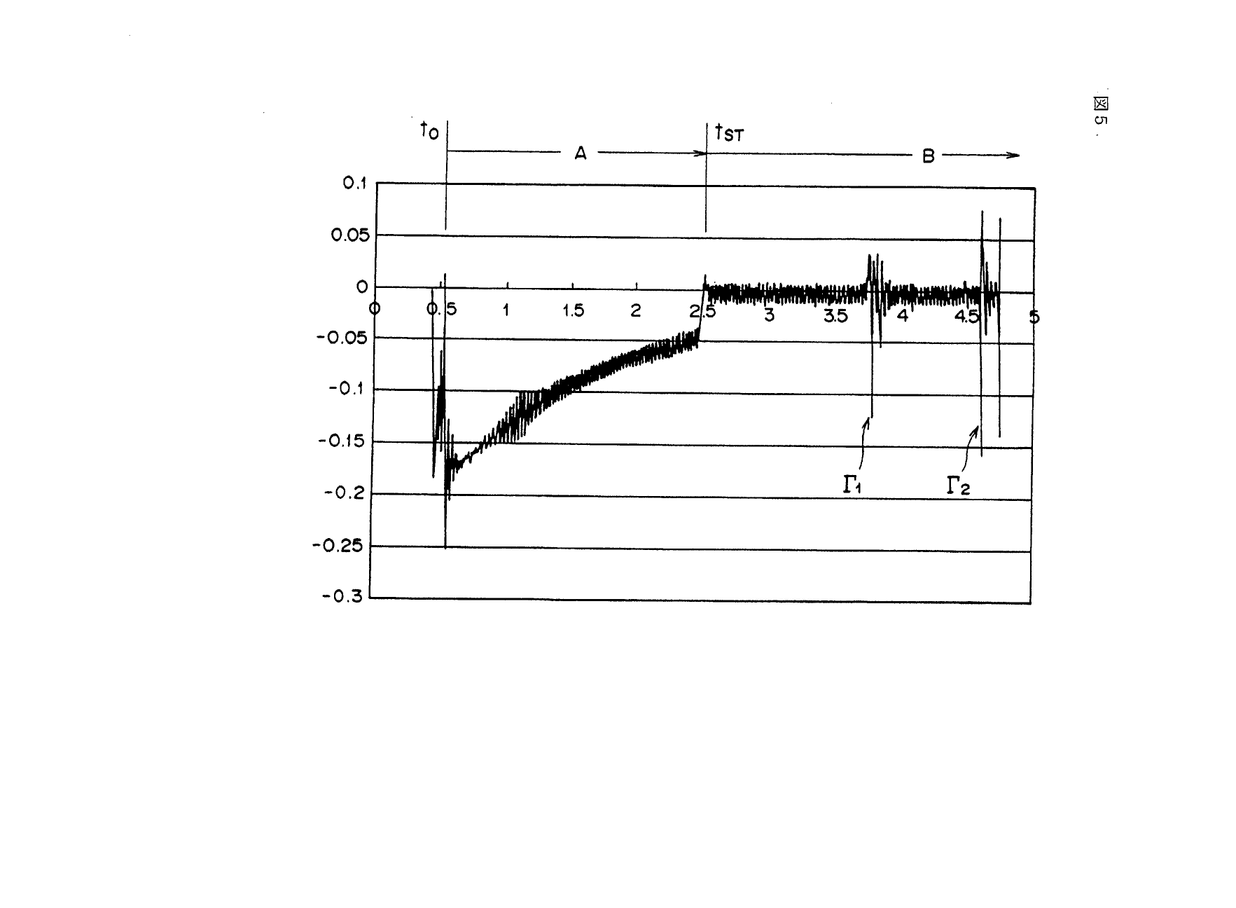

The same analysis as described above can also be applied to the case where the read head 2 is equipped with a driving mechanism which does not rotate as shown in FIG. 2(a) but moves linearly. For example, as shown in FIG. 4, when an actuator AA of mass m_{H} used for reading recording information from a track of a recording medium moves linearly in a direction X in the driving unit and when the center of the torque sensor BB attached to the driving unit is positioned at a distance L from the actuator AA in a direction perpendicular to the direction X, torque Mₛ(t) acting on the torque sensor BB at the point of time t is given as the expression (14):

$${M}_{s} ( t ) = {m}_{H} L \frac{{ⅆ}^{2} X ( t )}{ⅆ {t}^{2}} \qquad ( 14 )$$

in which X(t) is the position from the origin of the x reference coordinates to the center of gravity of the actuator AA at the point of time t. Hence, if the speed and the position of the read head 2 under the initial condition are zero for the simplification of description, the speed in linear motion and position of the read head 2 at the point of time t can be determined as shown below by time-integrating the expression (14) once and twice, respectively.

$$\begin{matrix}\frac{ⅆ X ( t )}{ⅆ t} = \frac{1}{{m}_{H} L} {\int }_{{t}_{0}}^{t} {M}_{s} ( t ) ⅆ t & ( 15 ) \\ X ( t ) = \frac{1}{{m}_{H} L} {\int }_{{t}_{0}}^{t} ⅆ {t}^{′} {\int }_{{t}_{0}}^{{t}^{′}} ⅆ {tM}_{s} ( t ) & ( 16 )\end{matrix}$$

In this manner, the motion of the read head 2 can be clarified.

Embodiment

An example of measurement of a driving unit of a currently used hard disk by the method according to the present invention will be described below.

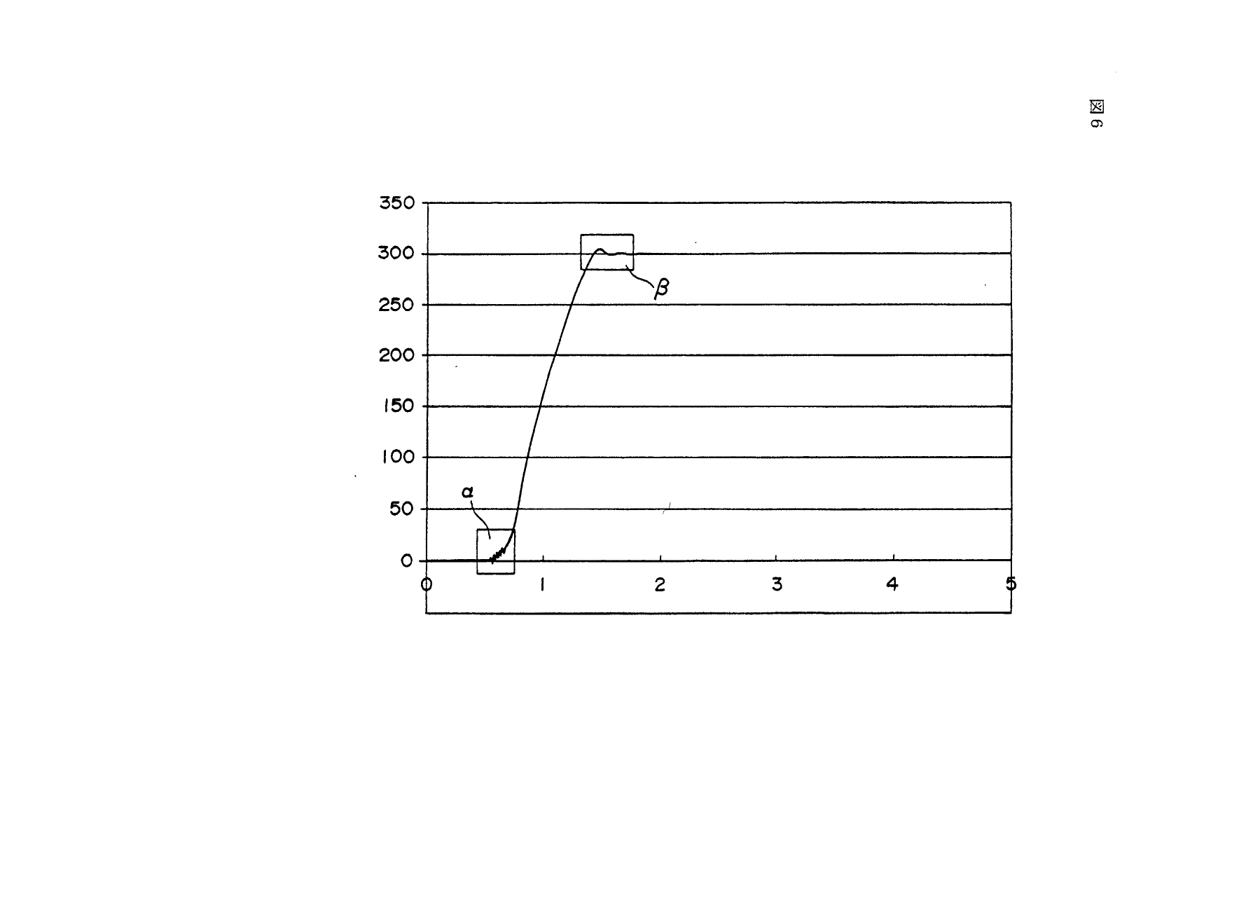

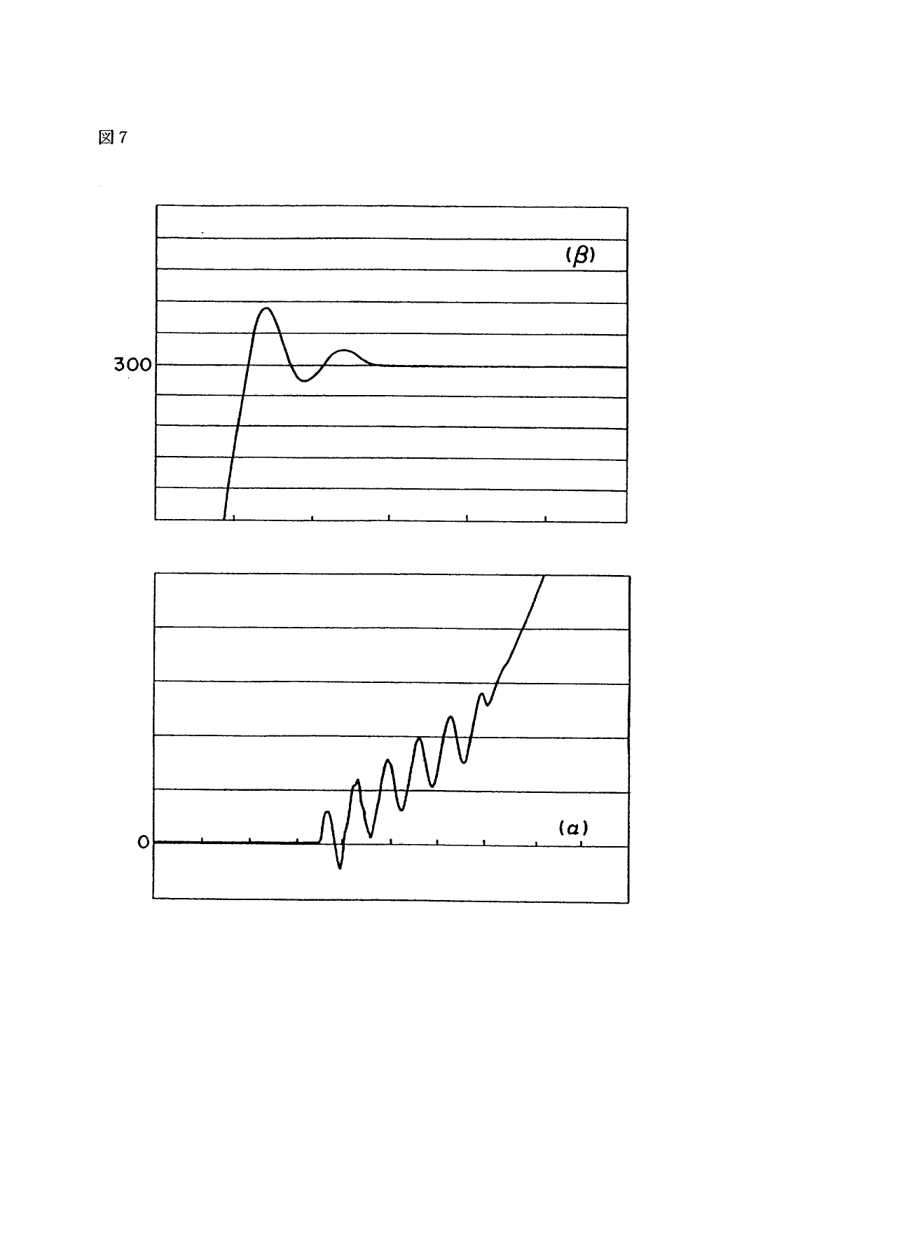

FIG. 5 shows the time variation of a measured torque value at the start of rotation of the disk in the case where the read head is mounted. The rotation reaches a steady state at about 2.5 sec. after the rotation starts. The disturbance of the torque curve just after the start of rotation shows the disturbance caused when static friction between the disk surface and the read head is overcome. Although the measured value is subjected to a simple filtering process, the measured value still suffers a large spike-like fluctuation. FIG. 6 shows a time-integrated value of the measured torque value in FIG. 5. In the case, the spike-like fluctuation of the measured torque is averaged by integration, so that the subsequent analysis can be carried out more accurately. FIG. 7 shows an enlarged portion in a vicinity of the start of the rotation and an enlarged portion in the vicinity of the point of time when the rotation reaches a steady state in FIG. 6. That is, FIG. 7 shows details of a period of about 0.5 sec. just after the start of rotation affected by static friction and a period of about 0.5 sec. after the point of time when the rotation reaches a steady state.

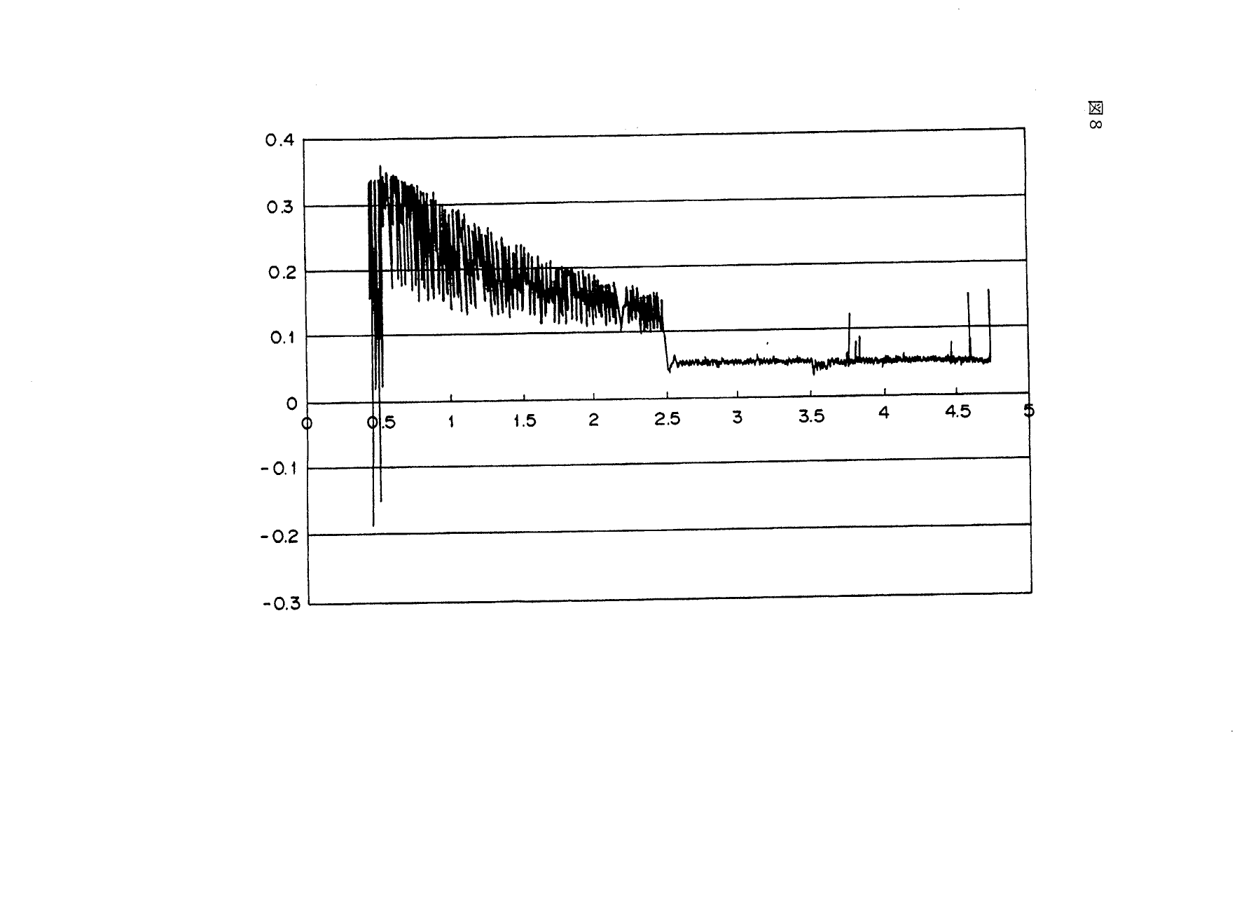

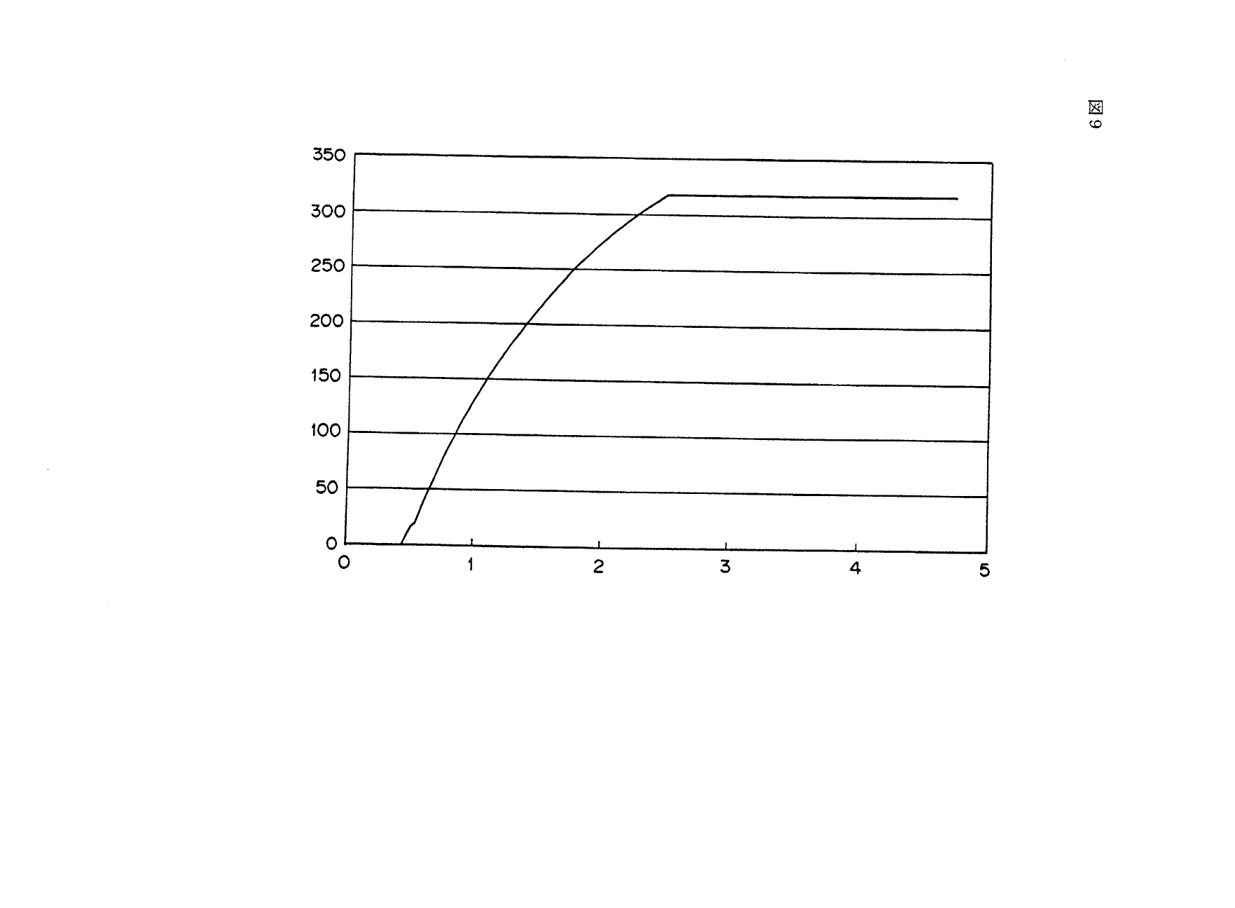

FIG. 8 shows the time variation of a motor-driving current under conditions corresponding to those in FIG. 5. Also in this case, a large spike-like current fluctuation is superimposed on the driving current. It is conceived that the fluctuation contains fluctuation of a switching transistor because an inverter type electric power supply is employed as the driving electric power supply. FIG. 9 shows the time-integrated value of the driving current in FIG. 8. Also in this case, averaging due to time-integration is observed.

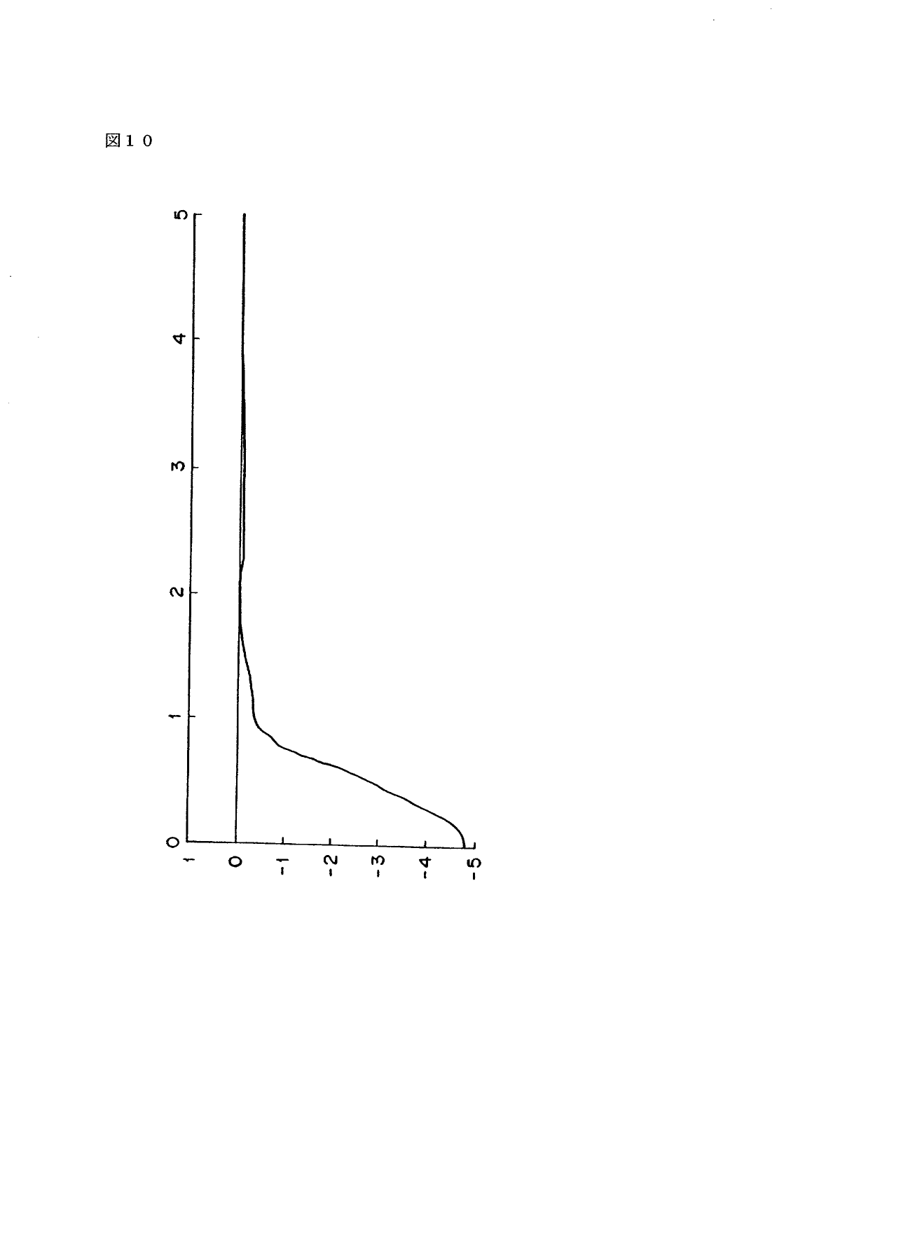

FIG. 10 shows the difference between the time-integrated value of the torque in FIG. 6 and the time-integrated value of the motor-driving current in FIG. 9. This diagram shows the time variation over a period from 0 sec. to 1 sec. where the friction force acts most intensively between the disk surface and the read head.

FIG. 11 shows the time variation of the time-integrated value of measured torque characteristic at the start of rotation, in the case where the read head is mounted (broken line) and in the case where the read head is not mounted (solid line). It can be confirmed clearly that arrival of such a steady rotation state is delayed by friction due to the head.

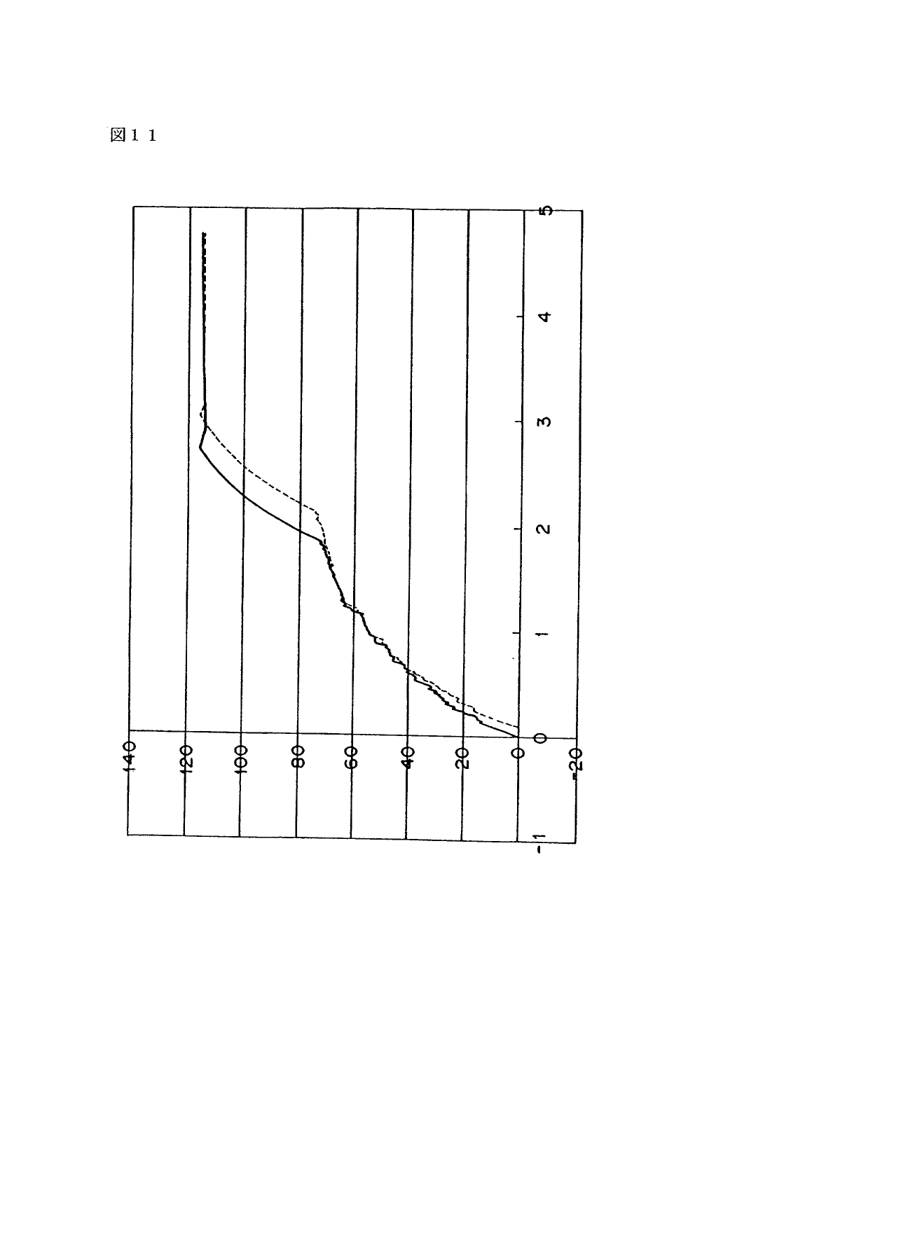

FIG. 12 also shows the time variation of the time-integrated value of measured torque characteristic at the stop of rotation, in the case where the read head is mounted (broken line) and in the case where the read head is not mounted (solid line). Also in this case, the time for stopping the disk is shortened by friction due to the head.

Next, the torque waveform shown in FIG. 5 will be examined once more in detail. After the rotation of the disk reaches a steady state B, the torque sensor 12 sometimes exhibits strong torque fluctuation at points Γ₁ and Γ₂. This fluctuation is caused by sudden motion of the actuator portion of the read head at a seeking operation. Generally, such a sudden fluctuation while the disk rotates in the steady state is caused by, in one case, sudden motion of the actuator portion as shown in FIG. 5, and, in another case, by a damage or foreign matter such as dust on the disk surface. These two cases can be discriminated from each other whether the driving current applied to the armature 4 of the actuator for turning the arm 3 of the read head 2 exists or not. That is, if a current applied to the armature generates, it can be found that the sudden torque fluctuation is caused by positive motion of the actuator. If no current applied to the armature generates, it can be found that the sudden torque fluctuation is caused by passive motion of the actuator.

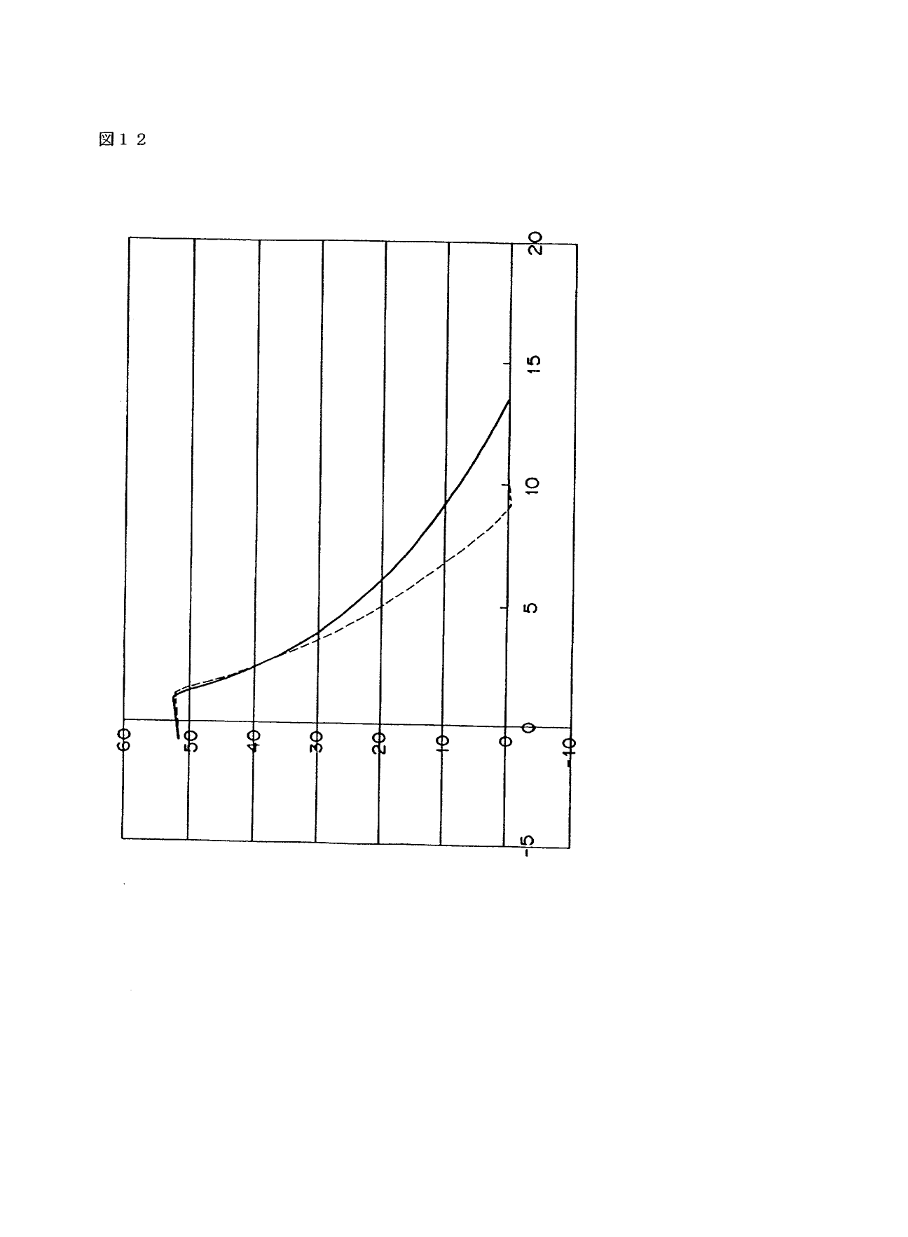

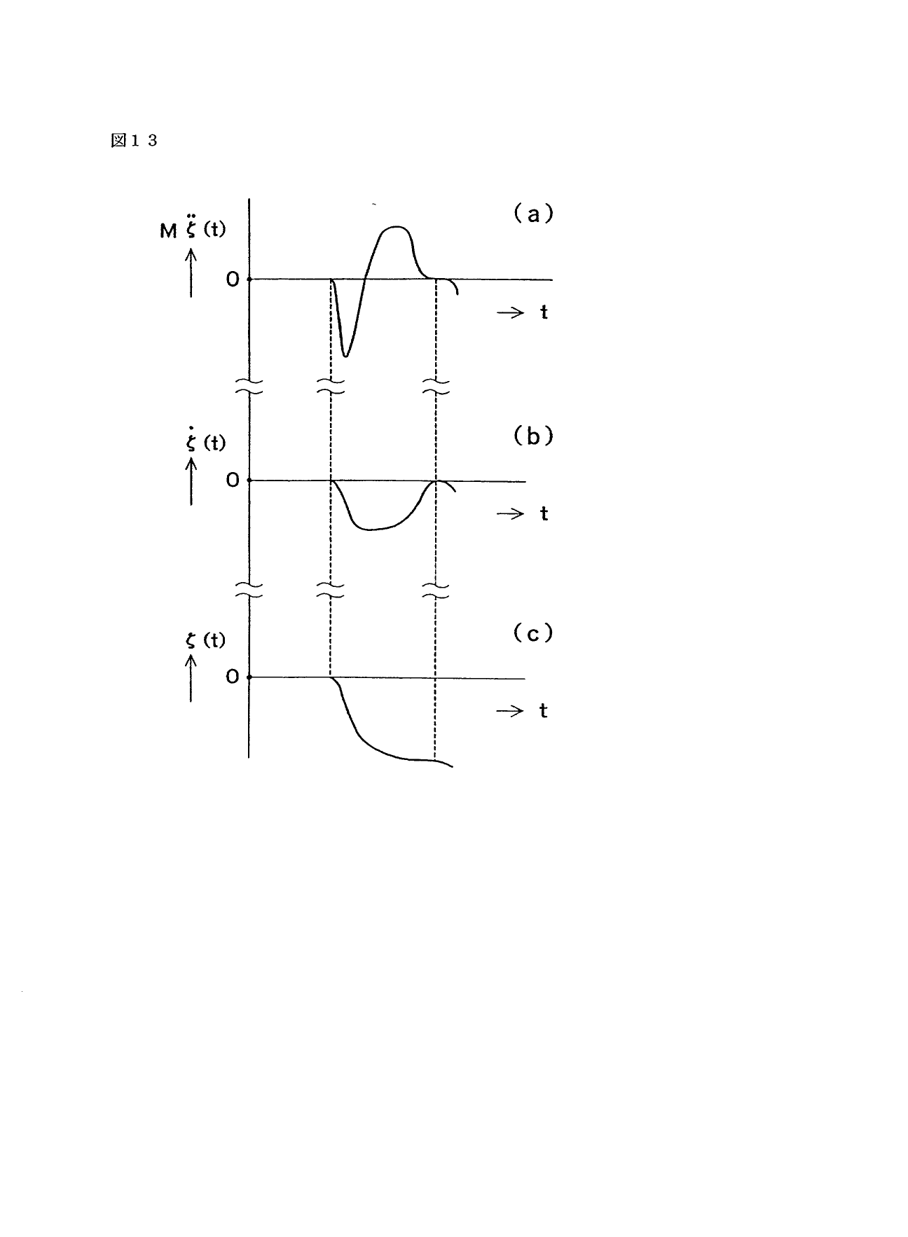

If such fluctuation is caused by the former reason, the torque value detected as shown in FIG. 13(a) is time-integrated once and twice in accordance with the expressions (12) and (13), thereby determining them as the rotational angular speed and rotation angle ζ(t) of the head as shown in FIGS. 13(b) and 13(c). Hence, the behavior and seek speed of the read head at the seeking operation can be estimated. When the read head 2 moves linearly, the acceleration, speed and position of the read head tracking mechanism can be determined from the expression (13).

Though not described in detail, if the value of current applied to the armature 4 is measured and the pure moment of rotation of the actuator generated in the energizing current itself is measured in advance, friction or braking characteristic between the read head and the disk at the seeking operation can be estimated on the basis of the difference between the torque value measured at the seeking operation and the pure moment of rotation determined on the basis of the applied current, similarly to the case described in FIG. 10 in which the braking characteristic of the disk is examined on the basis of the operation of the disk-rotating mechanism.

In the aforementioned example of measurement, the numerical values (vertical axes) are shown as optional values which are not particularly specified in terms of unit. In practical evaluation of the driving unit, the quality of the driving unit can be judged by providing specific threshold values, respectively for the measured torque value and/or the amplitude of the time-integrated value thereof and the frequency of occurrence thereof in accordance with the purpose of use and respective demand of the user.

As described above, in the method and apparatus according to the present invention, the torque characteristic of a driving unit of a recording medium disk such as a floppy disk, a hard disk or an optical disk can be measured accurately as it is without dismantling the driving unit. On the basis of the torque value, the mechanical quality of the rotation driving mechanism, the friction between the read head and the disk, the mechanical quality of the behavior of the read head and the quality of the electric characteristic of the rotation control system can be determined easily as numerical values.

What is claimed is:

1. A method for evaluating mechanical driving characteristics of a driving unit of a storage medium disk, said driving unit having a storage medium disk rotating mechanism including an electric motor, and a storage information track tracking mechanism including a read head provided for reading storage information written in said storage medium disk, comprising the steps of:
measuring the torque of the whole of said driving unit over a predetermined period of rotation; and
determining the mechanical driving characteristics of said driving unit from the time variation of said measured torque value.

2. A method according to claim 1, wherein driving characteristics of said storage medium disk rotating mechanism are used as said mechanical driving characteristics.

3. A method according to claim 1, wherein driving characteristics of said storage information track tracking mechanism are used as said mechanical driving characteristics.

4. A method according to claim 3, wherein said driving characteristics of said storage information track tracking mechanism are measured while said storage medium disk rotating mechanism rotates in a steady state.

5. A method according to claim 1, wherein mechanical driving characteristics resultant from the braking action generated between said storage medium disk and said read head are used as said mechanical driving characteristics.

6. A method according to any one of claims 1 to 5, wherein said mechanical driving characteristics are evaluated on the basis of a value determined by time-integrating said measured torque value once over a predetermined period of time.

7. A method according to any one of claims 1 to 5, wherein said mechanical driving characteristics are evaluated on the basis of a value determined by time-integrating said measured torque value twice over a predetermined period of time.

8. A method according to any one of claims 1 to 7, wherein in conjunction with the measurement of said torque value, a current value determined by measuring a driving current of said electric motor over a measurement period is included for the evaluation of said mechanical driving characteristics.

9. A method according to any one of claims 1 to 7, wherein a value determined by time-integrating said driving current of said electric motor over a predetermined period of time is included for the evaluation of said mechanical driving characteristics.

10. A method according to any one of claims 1 to 9, wherein mechanical driving characteristics resultant from braking action generated between said storage medium disk and said read head are evaluated on the basis of a value determined by subtracting said time-integrated value of said driving current of said electric motor simultaneously measured with the torque value from said time-integrated value of said measured torque value.

11. An apparatus for carrying out a method according to any one of claims 1 to 10, comprising:
a torque sensor 12 removably mounted to a driving unit 10 having a disk rotating mechanism including a storage medium disk 1 and a storage information track tracking mechanism including a read head 2 provided for reading storage information from said storage medium disk 1; and
an evaluation processing unit (ES) having a ROM for storing an operation program to process a torque detection signal, a RAM for temporarily storing data of said torque detection signal and processing signals, a processing portion, a display/recording unit, and a switching unit for sending a measurement start/stop instruction signal to an electronic control unit (DT) for supplying a driving current to a motor 6 of said disk rotating mechanism.

12. An apparatus according to claim 11, wherein a current sensor (S) which supplies a current signal detected by said current sensor (S) to said evaluation processing unit (ES) is disposed in a lead wire (L1) between said electronic control unit (DT) and said motor 6 in order to monitor said driving current of said motor 6 of said disk rotating mechanism.
